(19) United States
(12) Patent Application Publication
(10) Pub. No.: US 2011/0088652 A1
(43) Pub. Date: Apr. 21, 2011

(54) Ram induction system

(76) Inventor: Frederick A. Rockenbach, Papillion, NE (US)

(21) Appl. No.: 12/589,273

(22) Filed: Oct. 21, 2009

(51) Int. Cl. F02M 35/02; B01D 45/08; B01D 50/00

(52) U.S. Cl. 123/198 E; 95/272; 55/320; 55/328

(57) ABSTRACT

The method of separating contaminants from a stream of incoming contaminated air to an engine is disclosed wherein the incoming contaminated air stream is separated into a relatively clean air stream and a relatively dirty air stream with the relatively clean air stream being directed to the inlet of the engine and with the relatively dirty air stream being directed to one or more purge exits and out of the system, thereby causing the purged air stream to carry at least some of the original contaminants from the incoming air stream.

### BACKGROUND OF THE INVENTION

1. Field of the Invention

This invention relates to a ram induction system and more particularly to a ram induction system that separates contaminants from the inducted stream.

2. Description of the Related Art

A Ram Induction System (RIS) is a fluid induction system that makes use of the dynamic pressure of a moving fluid stream to boost the static pressure of the supplied fluid for some purpose. This basic principal has been used in aircraft, auto racing, and other venues for nearly a century. A typical RIS system for an internal engine vehicle will consist of an air inlet that faces the direction of the vehicular travel such that the oncoming air impinges directly on the air inlet. As the impinging air slows down inside the RIS, the pressure of the air increases and this pressurized air is then supplied to the engine, resulting in a potential increase engine power. While an increase in potential engine power is desirable, one thing that is not desirable is that airborne contaminants, (e.g., dust, gravel, bugs, dirt, water, birds, etc.) are scooped up by the RIS inlet and sent directly to the engine's combustion air supply. Many RIS systems include a conventional air filtration system, (e.g., an automobile's paper filter element) to remove these contaminants. In this case, the service life of the filter is shortened by the increase in contaminants supplied by the RIS system. In other systems (e.g. aircraft turbines and many racing craft), the contaminants are sent to the engine without the benefit of filtration. This results in the reduced service life of the engine. In the case of a Canadian goose or the like being ingested by an aircraft, this may well result in a drastically shortened life of the entire aircraft.

### SUMMARY OF THE INVENTION

This Summary is provided to introduce a selection of concepts in a simplified form that are further described below in the Detailed Description. This Summary is not intended to identify key aspects or essential aspects of the claimed subject matter. Moreover, this Summary is not intended for use as an aid in determining the scope of the claimed subject matter.

A method and means for separating contaminants from the inducted air stream of a ram induction system is disclosed. In one embodiment, the method of separating contaminants from the inducted stream of air of a ram induction system for an internal combustion engine, having an air inlet, is disclosed. The method comprises the steps of: (1) routing the incoming contaminated air stream to separate the contaminated air into a relatively clean air stream and a relatively dirty air stream; (2) directing the relatively clean air stream to the inlet of the engine; and (3) routing the relatively dirty air stream through one or more purge exits and out of the system thereby causing the purged air stream to carry at least some, and preferably a substantial portion thereof from the incoming air stream. The method and means of this invention is well suited for internal combustion engines as well as aircraft turbine engines. The method and means of this invention is particularly well suited for use with an air cleaner on a motorcycle engine.

It is therefore a principal object of the invention to provide a method and means for separating contaminants from the inducted stream of an air ram induction system for internal combustion engines.

A further object of the invention is to provide a method and means of the type described which routes the incoming contaminated air stream of the system to separate the contaminated air stream into a relatively clean air stream and a relatively dirty air stream with the relatively clean air stream being directed to the inlet of the engine with the dirty air stream being routed through one or more purge exits and out of the system causing the purged air stream to carry at least some of the original contaminants from the incoming air stream.

A further object of the invention is to provide a method and means for separating contaminants from the incoming air stream of an aircraft turbine engine.

A further object of the invention is to provide a method and means for separating contaminants from an air stream passing to the air intake system of an internal combustion engine which reduces the amount of contaminants passing to an air filter of the engine.

A further object of the invention is to provide structure to be used in conjunction with a ram induction system (RIS) to supply fluid such as air thereto for any purpose.

A further object of the invention is to provide a system for supplying clean air to an internal combustion piston engine.

A further object of the invention is to provide a method and means for supplying air to a gas turbine engine.

A further object of the invention is to provide a method and means for supplying air to a cooling system.

A further object of the invention is to provide a method and means for supplying air to drive a wind turbine.

A further object of the invention is to provide a method and means for supplying clean gas to sensors.

These and other objects will be apparent to those skilled in the art.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a perspective view of a vehicle having an internal combustion engine with the structure of this invention mounted thereon;

FIG. 2 is an exploded perspective view of a system of FIG. 1;

FIG. 3 is a horizontal sectional view of the structure of FIG. 2;

FIG. 4 is an exploded perspective view of a modified form of the invention;

FIG. 5 is a schematic view illustrating a dual air induction system for a turbine of an aircraft;

FIG. 6 is a sectional view illustrating another form of the invention used in supplying clean air to the turbine of a turbine engine;

FIG. 7 is a side view of a motorcycle having the embodiment of FIG. 4 mounted thereon; and

FIG. 8 is a perspective view of a further embodiment of the invention with a portion thereof cut away to more fully illustrate the invention.

### DESCRIPTION OF THE PREFERRED METHOD AND MEANS

Embodiments are described more fully below with reference to the accompanying figures, which form a part hereof and show, by way of illustration, specific exemplary embodiments. These embodiments are disclosed in sufficient detail to enable those skilled in the art to practice the invention. However, embodiments may be implemented in many different forms and should not be construed as being limited to the embodiments set forth herein. The following detailed description is, therefore, not to be taken in a limiting sense in that the scope of the present invention is defined only by the appended claims.

The various embodiments disclosed herein are illustrated as being used with an incoming air stream to either an internal combustion engine or a gas turbine, but it should be understood that the method and means of this invention may be used to separate contaminants from any fluid.

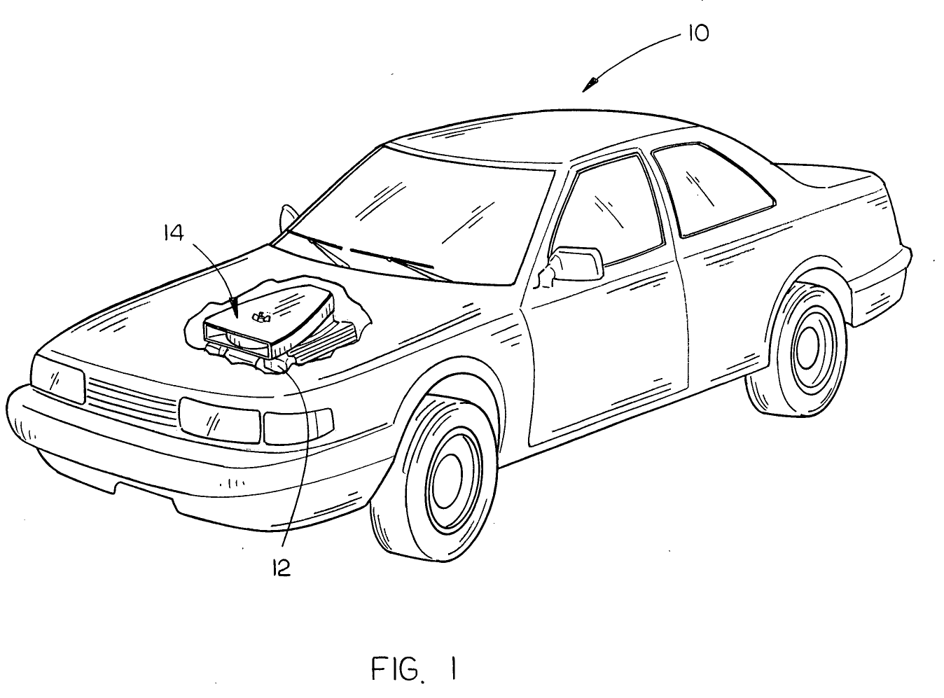

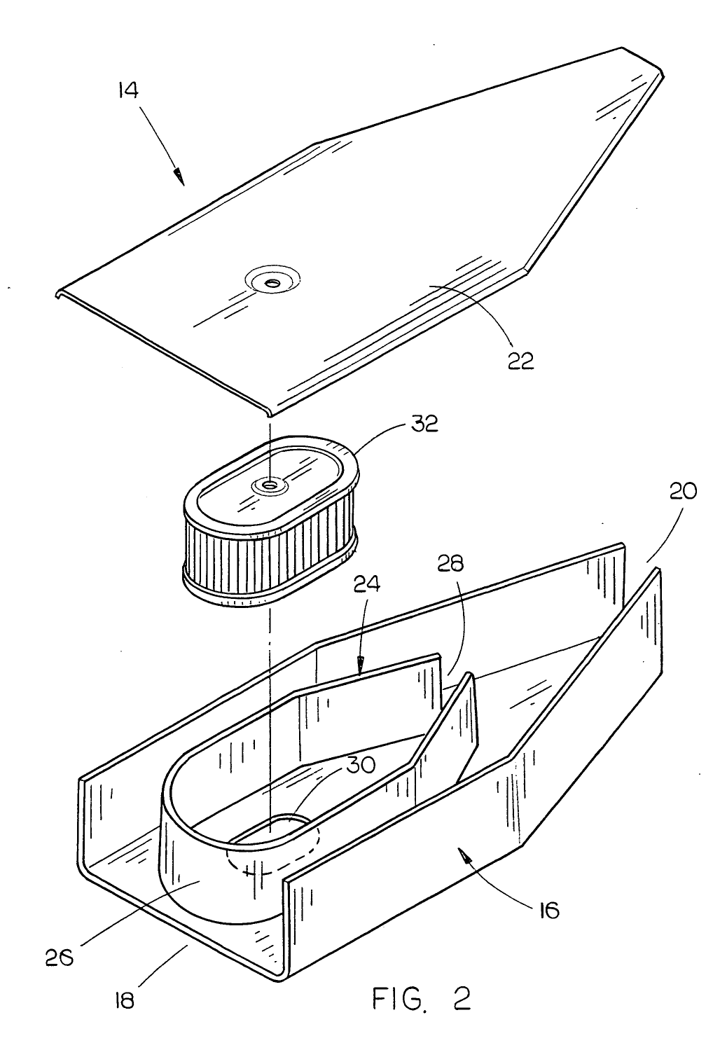

In FIG. 1, the numeral 10 refers to a vehicle having an internal combustion engine 12 mounted in the engine compartment in conventional fashion. The numeral 14 refers to one form of the means or structure for separating the contaminants in the incoming air stream so that the contaminants are not directed to the air intake of the engine 12. The invention 14 may be completely mounted within the engine compartment below the hood of the vehicle or may be positioned above the hood if so desired. If the invention 14 is positioned below the hood, ducting would be required from the front of the vehicle to the invention 14.

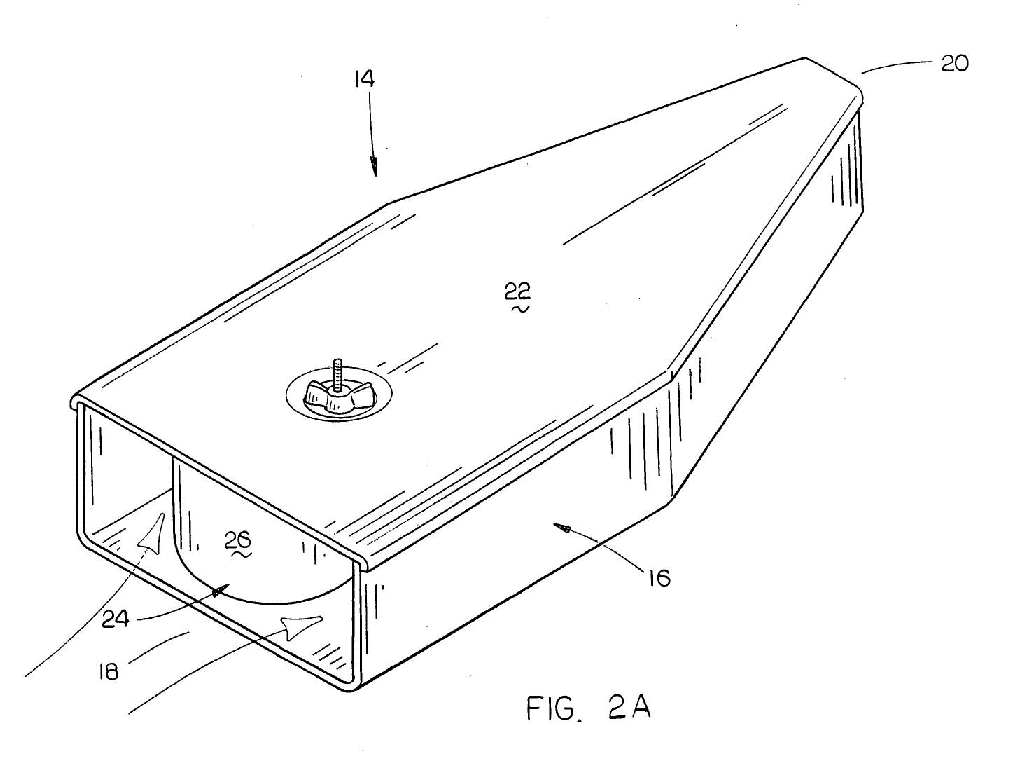

The system 14 is illustrated in exploded perspective form in FIG. 2 and includes an outer casing 16 having an intake end 18 and a discharge end 20. The upper end of casing or housing 16 is closed by a suitable lid or cover 22. The numeral 24 refers to an air filter shroud having a closed forward end 26 and an open rearward end 28. The bottom wall of casing 16 has an opening 30 formed therein which is located within the confines of the air filter shroud 24 and which is in communication with the engine air inlet. The numeral 32 refers to an air cleaner or filter element which is positioned over the opening 30. For purposes of description, the numeral 34 refers to a purge exit which may be adjustable if so desired.

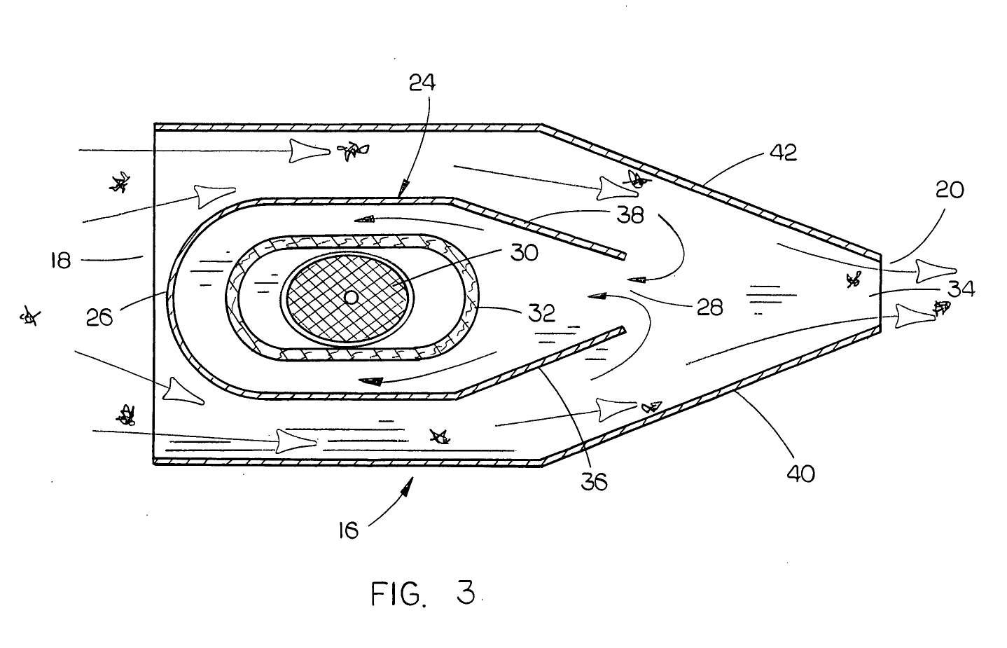

The incoming contaminated air enters the open forward end 18 of casing 16 as illustrated in FIG. 3. The contaminated air stream passes around the exterior surface of the air filter shroud 26 as illustrated by the arrows in FIG. 3. The downstream side of shroud 26 includes the inwardly extending wall portions 36 and 38 as also seen in FIG. 3. The incoming air strikes the tapered wall portions 40 and 42 of the casing 16 which serves to route or separate the contaminated air stream into a relatively dirty air stream and into a relatively clean air stream as illustrated by the arrows in FIG. 3. The relatively dirty air stream is purged from the system outwardly through the purge exit 34 at end 20 of casing 16. The relatively clean air stream is routed so as to be directed into the open end 28 of shroud 24 so that the relatively clean air will pass through the filter element 32 into the air intake of the engine. The fact that a large portion of the contaminants are prevented from coming into contact with the filter element 32 results in a greater life for the filter 32.

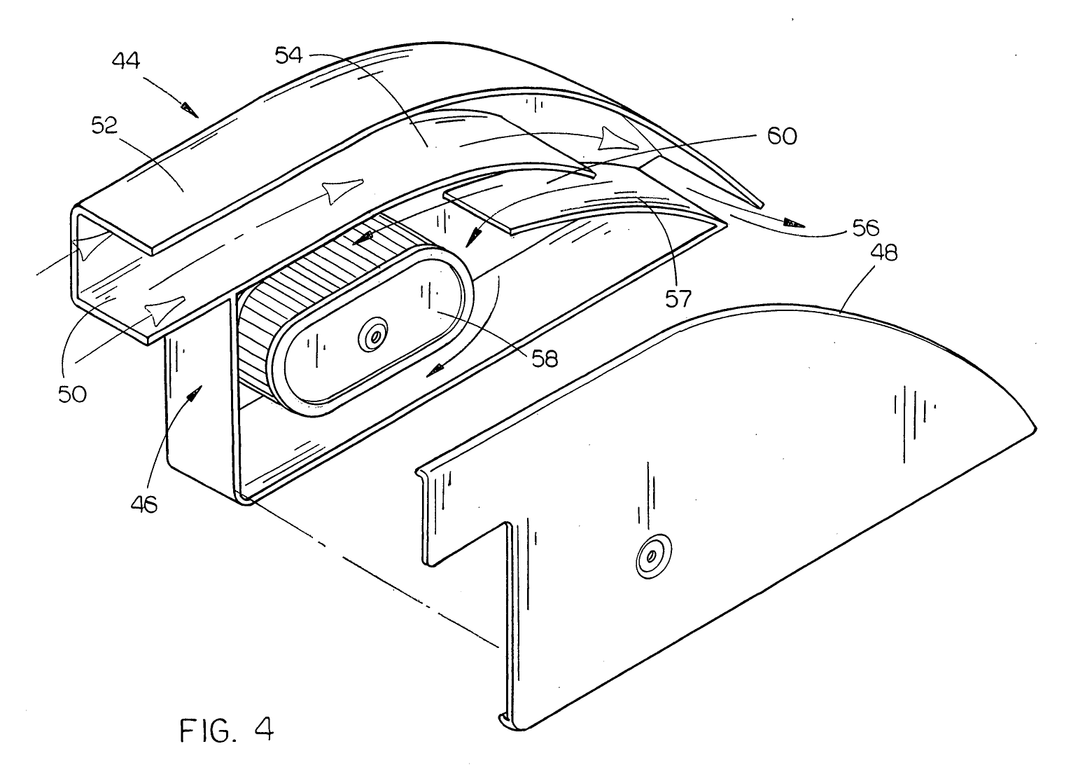

FIG. 4 illustrates, in exploded perspective form, a system 44 which may be used with a motorcycle 46 having an air intake opening at one side of the motorcycle. The system 44 includes an outer casing 46 having the outer side thereof closed by a cover or lid 48. The system 44 has an air inlet 50 which is defined by an upper wall 52 and a lower wall 54. As seen in FIG. 4, the walls 52 and 54 are curved downwardly at their downstream ends so that the contaminated air stream will strike the inner surface of the upper wall 52 as illustrated by the arrow in FIG. 4 so as to be able to pass downwardly through the purged exit 56 which may be adjustable if so desired. The numeral 58 refers to a filter element which is in communication with an opening in the inner side of the casing 46 which is in communication with the air intake of the motorcycle engine. Casing 46 also includes an upwardly curved wall 57 to define an air passageway 60 between the inner surface of lower wall 54 and the upper surface of wall 57.

Thus, the contaminated air stream enters the air inlet 50 of casing 46 and is routed so as to separate the contaminated air stream into a relatively clean air stream and a relatively dirty air stream. The relatively dirty air stream is directed out through the purge opening 56 and the relatively clean air stream passes through the passageway 60 so as to pass through the air filter element 58 and then into the air intake of the engine. The fact that the vast majority of the contaminants are purged from the system ensures that the air filter element 58 will have an extended life since it will not become clogged or filled with contaminants such as bugs, dirt, gravel, etc.

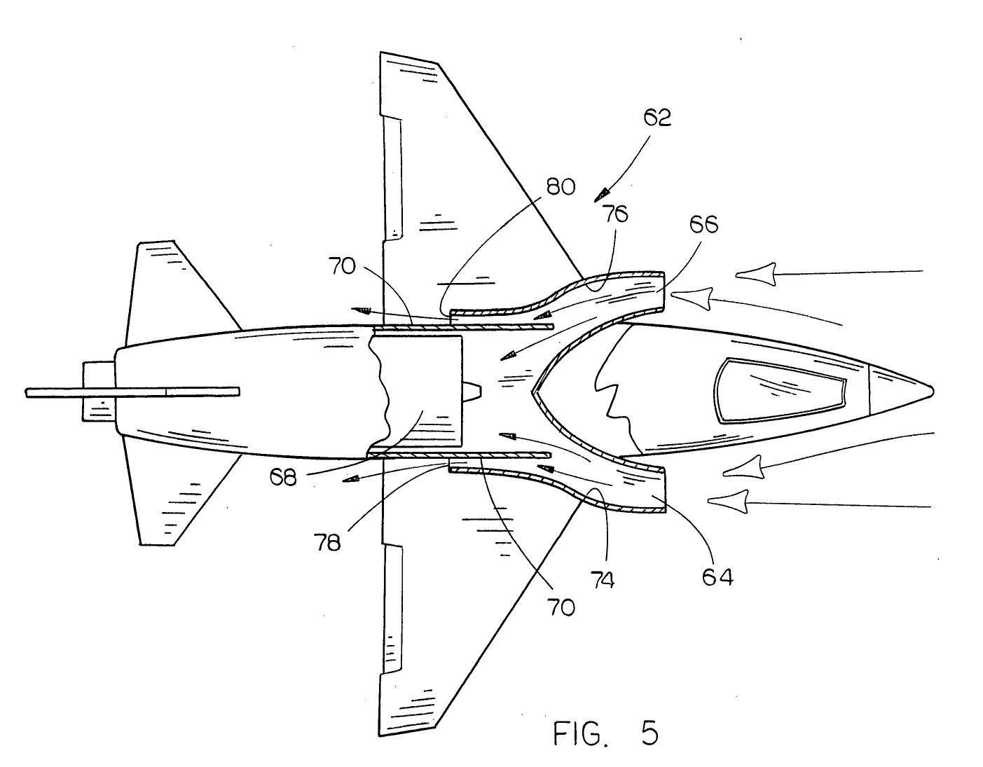

FIG. 5 is a top view of a single engine fighter aircraft having the system of this invention mounted thereon to separate contaminated incoming air into a relatively clean air stream and a relatively dirty air stream. The aircraft in FIG. 5 is designated by the reference numeral 62 and is provided with a pair of air intakes 64 and 66 through which passes the incoming contaminated air. The numeral 68 refers to the turbine of the aircraft. A shroud 70 extends forwardly from the turbine 68 outwardly thereof as illustrated in FIG. 5. As the incoming air enters the intakes 64 and 66, the air is routed or directed inwardly and rearwardly by the curved wall sections 74 and 76 to separate the contaminated air into a relatively clean air stream and into a relatively dirty air stream. The relatively dirty air stream is passed outwardly through the purge exits 78 and 80 with the relatively clean air stream being deflected or routed into the shroud 70 and into the turbine 68 as illustrated in FIG. 5. Thus, contaminants such as birds, water, etc. will be directed out of the purge exits 78 and 80 with only the substantially clean air stream being directed to the turbine 68.

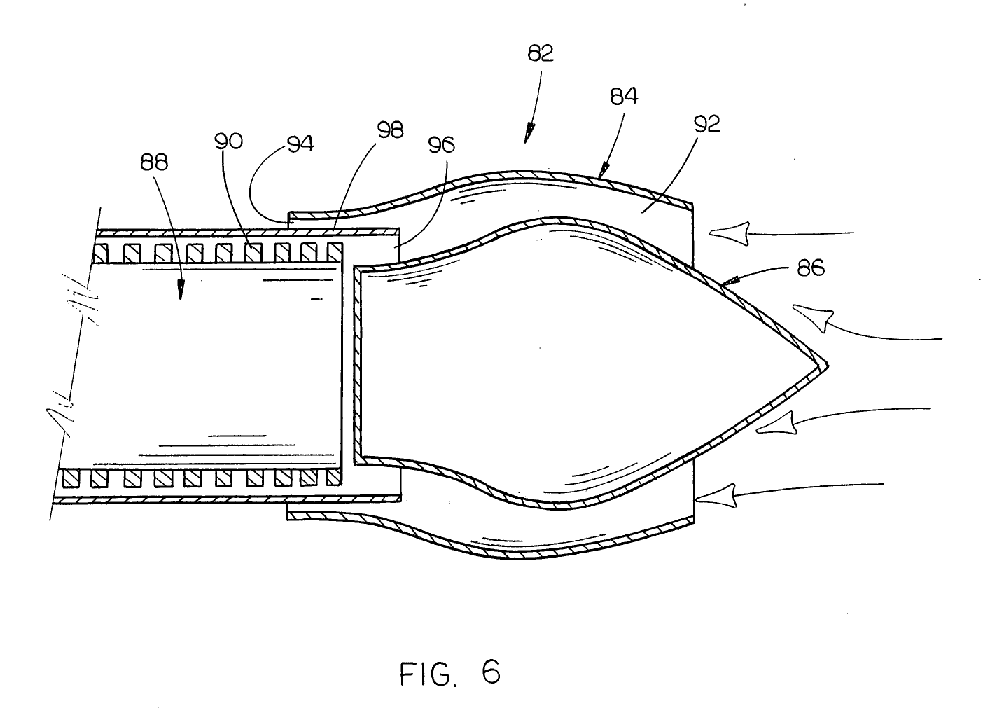

FIG. 6 is a partial cross-sectional view of the concept of this invention applied to a conventional airliner turbine. Although a turbo jet is shown, it could easily be applied to a turbine fan. In FIG. 6, the numeral 84 refers to an outer casing while the numeral 86 refers to a deflector casing within the outer casing 84. The numeral 88 refers to the compressor portion of the engine while the numeral 90 refers to compressor blades and stators. As seen in FIG. 6, the forward end of deflector casing 86 is bullet shaped at its forward end. As incoming air strikes the deflector casing 86, the air is directed into the air passageway 92 between the inner surface of outer casing 84 and the deflector casing 86. The complimentary shapes of the casings 84 and 86 cause the air stream to be initially moved outwardly and rearwardly so that the contaminated air stream is routed or separated into a relatively dirty air stream and a relatively clean air stream. The contaminants will strike the inner curved surface of the outer casing 84 so that the contaminants will be directed or routed outwardly through the purge exit 94 with the relatively clean air stream passing through the forward open end 96 of shroud 98. Thus, large contaminants such as birds, water, will pass outwardly through the purge opening 90 with the relatively clean air being supplied to the engine.

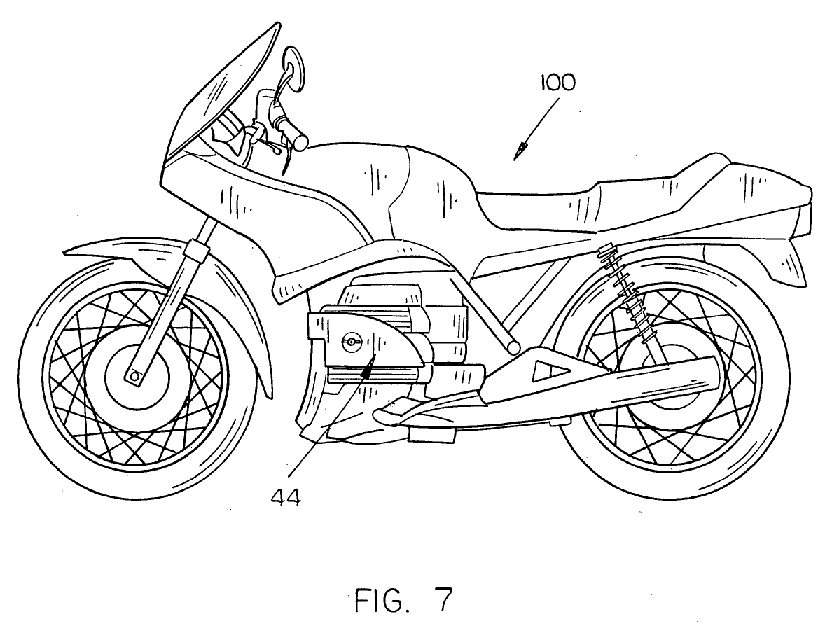

FIG. 7 illustrates a motorcycle 100 having the embodiment or system 44 mounted thereon. Ordinarily, the system 44 will be positioned on the right side of the motorcycle. When used on the motorcycle, bugs, dirt, etc. will be separated from the relatively clean air stream so that the relatively clean air stream is supplied to the filter and the engine.

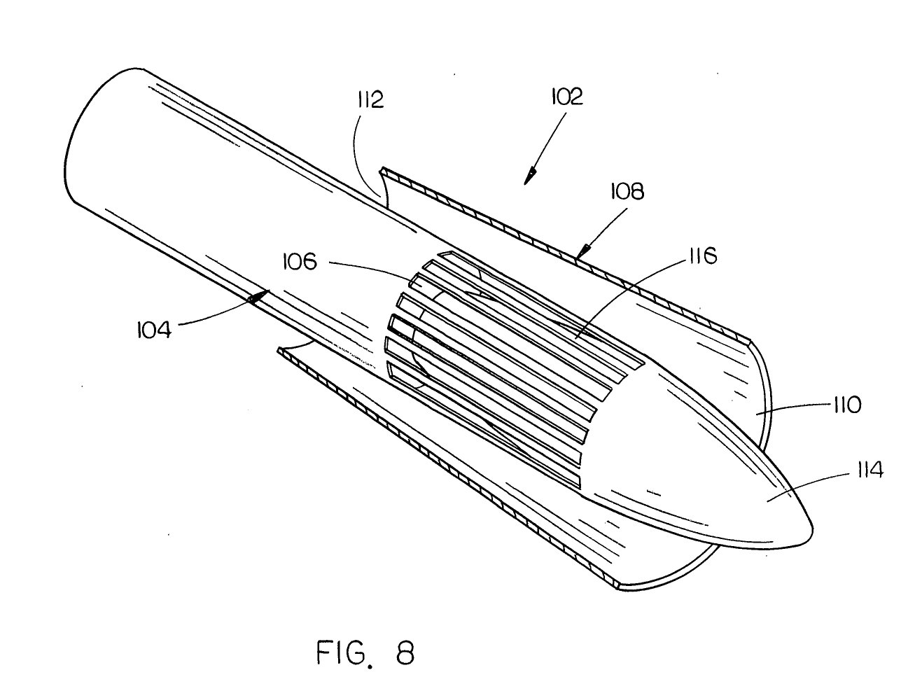

FIG. 8 illustrates a further embodiment of a jet engine and which is generally referred to by the reference numeral 102. The engine 102 includes a turbine 104 having a compressor inlet 106. An outer casing 108 is shown in a partially cut-away manner to fully illustrate the invention and extends around the forward part of the engine as seen in FIG. 8. Casing 108 has an air inlet end 110 and a purge exit 112 at its rearward end. A deflector casing 114 protrudes from the air inlet end 110 of the engine 102 as illustrated in FIG. 8 and has a plurality of deflector slats 116 extending rearwardly therefrom which are connected to the turbine 104 as seen in FIG. 8.

The deflector slats 116 may be of any geometry that simultaneously encourages (a) airflow to the turbine or turbo fan and (b) discourages undesirable foreign material or bodies such as geese or the like from following the air stream into the engine. Because the slats 116 will be impacted only tangentially by foreign bodies, the foreign bodies will likely maintain physical integrity and simply slide rearwardly and out through the purge exit 112.

In all of the embodiments, the size of the purge exit or exits is such that the purge exit or exits are large enough to allow contaminants to be purged from the system but small enough to create an air flow restriction that will result in sufficient back pressure to maintain a significant amount of the pressure increase created by the systems.

In summary, the method of separating contaminants from the inducted stream of air of a ram induction system (RIS) for an internal combustion engine having an air inlet comprises the steps of: (1) routing the incoming contaminated air stream to separate the contaminated air into a relatively clean air stream and a relatively dirty air stream; (2) directing the relatively clean air stream to the inlet of the engine; and (3) routing the relatively dirty air stream through one or more purge exits and out of the system, thereby causing the purged air stream to carry at least some of the original contaminants from the incoming air stream.

When used with an aircraft turbine engine, the method for separating contaminants from the inducted air stream of a jet engine comprises the steps of: (1) routing the incoming contaminated air stream to separate the contaminated air into a relatively clean air stream and a relatively dirty air stream; (2) directing the relatively clean air stream to the inlet of the jet aircraft engine; and (3) routing the relatively dirty air stream into one or more purge exits and out of the system thereby causing the purged air stream to carry at least some of the original contaminants from the incoming air stream.

Thus it can be seen that the invention accomplishes at least all of its stated objectives.

Although the invention has been described in language that is specific to certain structures and methodological steps, it is to be understood that the invention defined in the appended claims is not necessarily limited to the specific structures and/or steps described. Rather, the specific aspects and steps are described as forms of implementing the claimed invention. Since many embodiments of the invention can be practiced without departing from the spirit and scope of the invention, the invention resides in the claims hereinafter appended.

1. The method of separating contaminants from the inducted stream of air of a ram induction system for an internal combustion engine having an air inlet comprising the steps of:
routing the incoming contaminated air stream to separate the contaminated air stream into a relatively clean air stream and a relatively dirty air stream;
directing the relatively clean air stream to the inlet of the engine; and
routing the relatively dirty air stream through one or more purge exits and out of the system thereby causing the purged air stream to carry at least some of the original contaminants from the incoming air stream.

2. The method of claim 1 wherein a substantial amount of the contaminants are directed to the purge exit or exits.

3. The method of claim 1 wherein the size of the purge exit or exits is such that the purge exit or exits are large enough to allow contaminants to be purged from the system but small enough to create an air flow restriction that will result in sufficient back pressure to maintain a significant amount of the pressure increase created by the ram induction system.

4. The method of claim 1 wherein the internal combustion engine is mounted on a motorcycle.

5. The method of claim 4 wherein the engine air inlet is horizontally disposed at one side of the motorcycle.

6. The method of separating contaminants from the inducted system of air into an aircraft turbine engine having an air intake, comprising the steps of:
routing the incoming contaminated air stream to separate the contaminated air into a relatively clean air stream and a relatively dirty air stream;
directing the relatively clean air stream to the air inlet of the aircraft turbine engine; and
routing the relatively dirty air stream through one or more purge exits and out of the system thereby causing the purged air stream to carry at least some of the original contaminants from the incoming air stream.

7. The method of claim 6 wherein a substantial amount of the contaminants are directed to the purge exit or exits.

8. The method of claim 6 wherein the size of the purge exit or exits is such that the purge exit or exits are large enough to allow contaminants to be purged from the system but small enough to create an air flow restriction that will result in sufficient back pressure to maintain a significant amount of the pressure increase created by the system.

9. The method of claim 6 wherein a pair of contaminated air streams are inducted and wherein each of the air streams are routed to separate the contaminants thereon into a relatively clean air stream and a relatively dirty air stream.

10. The method of claim 6 wherein a substantial amount of the contaminants are directed to the purge exit or exits.

11. The method of claim 9 wherein substantially all of the contaminants are directed to the purge exit or exits.

12. The method of claim 1 wherein the purge exits are adjustable to permit varying flows of air therethrough.

13. The method of claim 6 wherein the purge exits are adjustable to permit varying flows of air therethrough.

14. The method of separating contaminants from an air stream passing to the air intake system of an internal combustion engine, comprising the steps of:
routing the incoming contaminated air stream to separate the contaminated air into a relatively clean air stream and a relatively dirty air stream;
directing the relatively clean air stream to the inlet of the engine; and
routing the relatively dirty air stream through one or more purge exits and out of the system thereby causing the purged air stream to carry at least some of the original contaminants from the incoming air stream.

15. The method of claim 14 wherein substantially all of the contaminants are directed to the purge exit or exits.

16. The method of claim 14 wherein the internal combustion engine is mounted on a motorcycle.

17. The method of claim 16 wherein the engine air inlet is horizontally disposed at one side of the motorcycle.

18. An air cleaner for an internal combustion engine having an air intake comprising:
a housing having an air inlet opening for receiving a contaminated air stream;
an air filter in said housing between said air inlet opening thereof and the engine air intake;
at least one purge exit in said housing;
structure in said housing which separates the contaminated air stream into a relatively clean air stream and a relatively dirty air stream and which directs the clean air stream to said air filter and which directs the dirty air stream to said purge exit or exits so that contaminants in the dirty air stream are purged from said housing.

19. The air cleaner of claim 18 wherein said purge exit or exits are adjustable.

20. The air cleaner of claim 18 wherein said structure includes baffles.

21. The method of claim 6 further including the step of providing a grill-like structure at the air intake of the engine to prevent large contaminants from entering the air intake.
